(19) United States
(12) Patent Application Publication
(10) Pub. No.: US 2025/0324020 A1
(43) Pub. Date: Oct. 16, 2025

(54) FULL COLOR HOLOGRAPHIC PROJECTOR WITH VARIABLE VIRTUAL IMAGE DISTANCE USING SINGLE COHERENT LIGHT SOURCE

(71) Applicant: GM GLOBAL TECHNOLOGY OPERATIONS LLC, Detroit, MI (US)

(72) Inventors: Kai-Han Chang, Madison Heights, MI (US); Thomas A. Seder, Fraser, MI (US)

(73) Assignee: GM GLOBAL TECHNOLOGY OPERATIONS LLC, Detroit, MI (US)

(21) Appl. No.: 18/635,868

(22) Filed: Apr. 15, 2024

(51) Int. Cl. H04N 9/31; G02B 26/00; G02B 27/01; G03H 1/22

(52) U.S. Cl. CPC H04N 9/3114; G02B 26/008; G02B 27/0103; G02B 27/0172; G03H 1/2205; G03H 1/2286; G03H 1/2294; H04N 9/3161; G02B 2027/0174; G02B 2027/0178; G03H 2001/2207; G03H 2001/2234; G03H 2222/12

(57) ABSTRACT

Disclosed is a product that may include a light source, a wavelength conversion structure downstream the light source, a spatial filter downstream the wavelength conversion structure, and a spatial light modulator downstream the spatial filter. Also disclosed is a method that may include sending a first light from a light source through a wavelength conversion structure to down convert the first light into a first primary color light, sending the first primary color light through a spatial filter to convert the first primary color light to spatially coherent first primary color light, sending the spatially coherent first primary color light through a spatial light modulator to convert the spatially coherent first primary color light to spatially and temporally enhanced first primary color light.

### INTRODUCTION

The technical field generally relates to holographic projectors, compartments thereof, and methods of using the same.

### BACKGROUND

Holographic projection as a picture generation unit has been known to include three lasers for full-color and three spatial light modulators for hologram projection and corresponding optical components for each color channel.

It is desirable to provide a picture generation unit with reduced number of components, weight, and cost. Furthermore, other desirable features and characteristics of the variations disclosed herein will become apparent from the subsequent detailed description and the appended claims, taken in conjunction with the accompanying drawings and the foregoing.

### SUMMARY

A number of variations may include a product including a light source, a wavelength conversion structure downstream the light source, a spatial filter downstream the wavelength conversion structure, and a spatial light modulator downstream the spatial filter.

A number of variations may include a product wherein the spatial filter includes a pinhole formed therein.

A number of variations may include a product wherein the spatial filter is constructed and arranged to adjust a size of the pinhole.

A number of variations may include a product wherein the pinhole has a diameter ranging from 500 micrometers to 100 micrometers.

A number of variations may include a product wherein the wavelength conversion structure includes at least one conversion material for selectively generating primary colors.

A number of variations may include a product wherein the wavelength conversion structure is constructed and arranged to enhance temporal coherence.

A number of variations may include a product wherein the spatial filter is constructed and arranged to enhance spatial coherence.

A number of variations may include a product wherein the wavelength conversion structure and the spatial light modulator are constructed and arranged to be driven at least three times a speed of a video source.

A number of variations may include a product wherein the wavelength conversion structure includes a phosphor material that can be excited to produce primary colors.

A number of variations may include a product wherein the wavelength conversion structure includes quantum dots that can be excited to produce primary colors.

A number of variations may include a method including sending a first light from a light source through a wavelength conversion structure to down convert the first light into a first primary color light; sending the first primary color light through a spatial filter to convert the first primary color light to spatially coherent first primary color light; sending the spatially coherent first primary color light through a spatial light modulator to convert the spatially coherent first primary color light to spatially and temporally enhanced first primary color light.

A number of variations may include a method further including thereafter sending a second light from the light source through the wavelength conversion structure to down convert the second light into a second primary color light; sending the second primary color light through the spatial filter to convert the second primary color light to spatially coherent second primary color light; sending the spatially coherent second primary color light through the spatial light modulator to convert the spatially coherent second primary color light to spatially and temporally enhanced second primary color light.

A number of variations may include a method further including thereafter sending a third light from the light source through the wavelength conversion structure to down convert the second light into a third primary color light; sending the third primary color light through the spatial filter to convert the third primary color light to spatially coherent third primary color light; sending the spatially coherent third primary color light through the spatial light modulator to convert the spatially coherent third primary color light to spatially and temporally enhanced third primary color light.

A number of variations may include a method wherein the spatial filter includes a pinhole formed therein.

A number of variations may include a method wherein the spatial filter includes a pinhole formed therein having a diameter ranging from 500 micrometers to 100 micrometers.

A number of variations may include a method wherein the wavelength conversion structure includes at least one conversion material for selectively generating primary colors.

A number of variations may include a method wherein the wavelength conversion structure is constructed and arranged to enhance temporal coherence.

A number of variations may include a method wherein the spatial filter is constructed and arranged to enhance spatial coherence.

A number of variations may include a method wherein the wavelength conversion structure and the spatial light modulator are driven at least three times a speed of a video source.

A number of variations may include a method including generating a signal from a computer or computing device and sending the signal to a digital micromirror device or a microelectromechanical system causing the digital micromirror device or the microelectromechanical system to generate an image for a video frame; calculating a hologram for the image for the video frame in three color channel; determining a laser pulse width required for each color; moving a waveguide conversion structure to a region with wavelength conversion material for green emission; addressing a spatial light modulator with the hologram for green and addressing a laser with a pulse width determined for green; moving the waveguide conversion structure to a region with wavelength conversion material for red emission; addressing the spatial light modulator with the hologram for red and addressing the laser with a pulse width determined for red; moving the waveguide conversion structure to a region without wavelength conversion material; addressing the spatial light modulator with the hologram for blue and addressing the laser with a pulse width determined for blue.

### BRIEF DESCRIPTION OF THE DRAWINGS

The variations will hereinafter be described in conjunction with the following drawing figures, wherein like numerals denote like elements, and wherein:

FIG. 1 is a schematic illustration of a product according to a number of variations;

FIG. 2 is a schematic illustration of a product including an image producer according to a number of variations;

FIG. 3 illustrates a method according to a number of variations;

FIG. 4 illustrates a product for producing a hologram in a head up display including a vehicle according to a number of variations;

FIG. 5 illustrates a product including a set of eyeglasses for displaying a hologram according to a number of variations; and

FIG. 6 illustrates a product including a set of goggles for displaying a hologram according to a number of variations;

FIG. 7 is a flow chart illustrating a method according to a number of variations; and

FIG. 8 is a flow chart illustrating a method according to a number of variations.

### DETAILED DESCRIPTION

The following detailed description is merely illustrative in nature and is not intended to limit the application and uses. Furthermore, there is no intention to be bound by any expressed or implied theory presented in the preceding technical field, background, brief summary or the following detailed description.

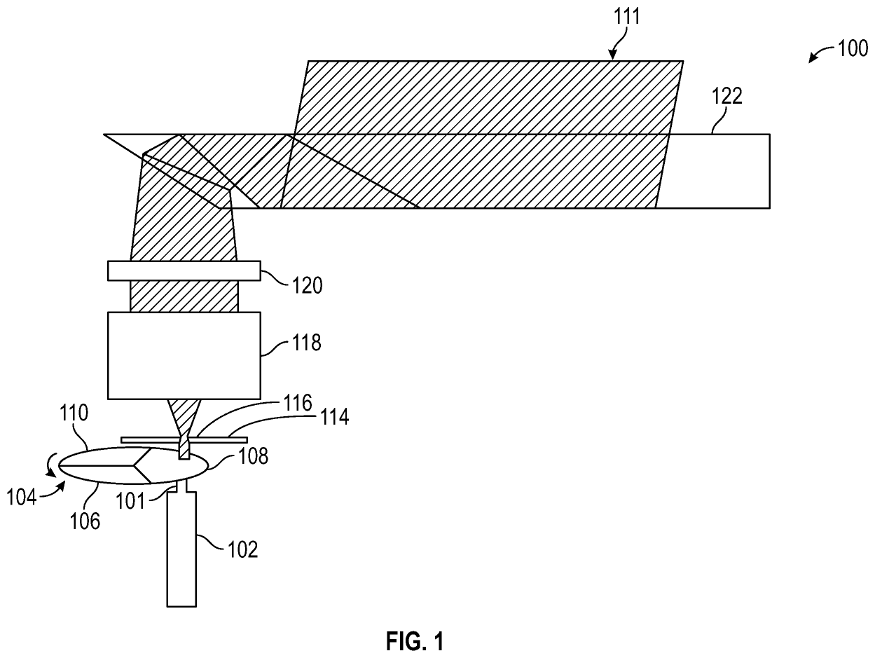

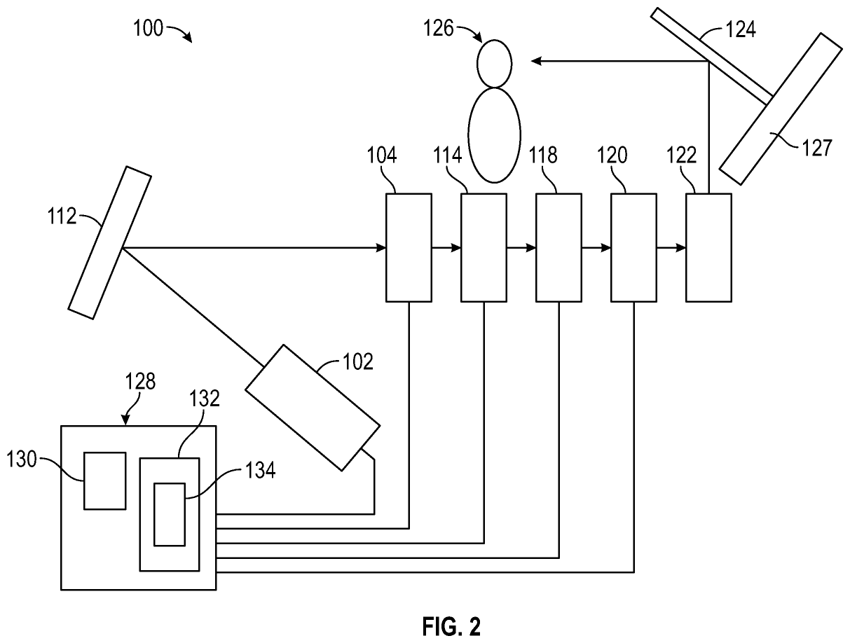

A number of variations are illustrated in FIGS. 1-2, which may include a product 100 which may be a holographic projector. The product 100 may include a light source 102 and a wavelength conversion structure 104 downstream of the light source 102. The term “downstream” as used herein means in the direction in which light flows from the light source 102. The light source 102 could be any of a variety of devices capable of producing one or more wavelengths of light 101. In a number of variations, the light source 102 may be a producing a light of a relatively short wavelength. In a number of variations, the light source 102 may be a laser emitting blue light. The wavelength conversion structure 104 may be constructed and arranged to allow light to pass therethrough and may be movable to a first position so that light passing through a first region 106 produces one of the primary colors, for example, red; and may be movable to a second position so that a light passing through a second region 108 produces a second primary color, for example, green; and movable to a third position so that light passing through a third region 110 produces a third primary color, for example, blue. The options of coating materials for wavelength conversion structure can be phosphor or quantum dots, which are capable of down converting incident light and emitting visible wavelength. The wavelength conversion structure 104 may be a rotatable plate or disk having three regions 106, 108, 110 defined therein so that so that light passing through one of the regions produces or emits one of the primary colors. In a number of variations, the three regions 106, 108, 110, of the rotatable plate or disk may have equal sizes. However, the wavelength conversion structure 104 is not limited to a disk configuration and may take on a variety of shapes to provide three distinct regions coated with material of options for producing the primary colors red, green, blue when light passes through a respective region. For example, the wavelength conversion structure 104 may be three plates extending radially from a shaft and rotatable so that one of the plates produces or emits one of the primary colors. In another example, the wavelength conversion structure 104 may be a substrate in the form of a strip having three regions through which light may pass to produce the three primary colors red, green, blue. In a number of variations, the wavelength conversion structure 104 may be coated with a phosphor material that may be excited by three different wavelengths to selectively produce the primary colors as light passes through one of the regions. In a number of variations, the wavelength conversion structure 104 may include quantum micro dots which may be selectively excited to produce the primary colors as light passes therethrough. One example of a means for exciting the phosphor or the quantum micro dots is by exciting the electrons of the material with light source with peak wavelength that matches the photonic bandgap of the material, which is chosen to be the wavelength of light source 102. The electron gets excited and moves to the upper band. During the relaxation process, the electron moves to the lower energy level and emit light of longer wavelength. The wavelength conversion structure 104 is designed for emitting primary colors red, green, and blue in different region. If the light source 102 is chosen to be blue, two out of three regions are coated with quantum dots or phosphors that emits red and green, with one out of three region without coating. If the light source is chosen to be outside of visible wavelength, the three regions are coated with quantum dots emitting red, green, and blue in the individual region. The size of the quantum dots determines the emission wavelengths as it controls the photonic bandgap. The phosphor's band gap is determined by chemical structure. In a number of variations, the wavelength conversion structure 104 may be a narrowband filter to enhance the temporal coherence of the light.

A number of variations are illustrated in FIG. 2, which may include an image producer 112, which may include, but is not limited to, a digital micromirror device (DMD) or a microelectromechanical system (MEMS). The DMD or MEMS may be a matrix or array of micromirrors that by changing orientation allows the light to be diverted or reflected in a controlled way to generate a pattern or image. The matrix or array of micromirrors may include over a million micromirrors. The image producer 112 may be interposed between the light source 102 and the wavelength conversion structure 104. The image producer 112 may generate a plurality of frames wherein each frame includes at least one object or image. The image producer 112 may generate the plurality of frames at a rate or speed (for example, X Hz).

Downstream of the wavelength conversion structure 104 is a spatial filter 114. The spatial filter 114 may be a planar substrate having a pinhole 116 form therethrough. In a number of variations, the pinhole 116 may be adjustable. In a number of variations, the pinhole 116 may have a diameter ranging from 500 μm (micrometers) to 100 μm. The pinhole 116 may be formed or adjusted to control the spatial coherence of the light passing therethrough. The pinhole 116 may be adjusted manually during the design and determine the optimum spatial coherence, or adjusted electronically with motorized iris.

A beam collimation optics system 118 may be positioned downstream from the spatial filter 114. The beam collimation optics system 118 may operate to cause the beam of light passing therethrough to maintain its size and shape over long distances.

A spatial light modulator (SLM) 120 may be provided downstream of the beam collimation optics system 118. The SLM may operate to control the intensity, phase, or polarization of light in a spatially varying manner.

A light waveguide 122 may be positioned downstream of the SLM 120. Light entering the light waveguide 122 may be directed a distance through the waveguide light and exit at a desired location.

In a number of variations, the light exiting the light waveguide 122 may be reflected by a transparent substrate 124 to be observed by a human 126 or an electronic device, such as but not limited to, an artificial intelligence computer or device for viewing and drawing inferences therefrom. In a number of variations, the transparent substrate 124 may comprise glass or another transparent material. In a number of variations, the transparent substrate 124 may be supported by a carrier 127. In a number of variations, the transparent substrate 124 be a windshield or a door windowpane of a vehicle (carrier 127) such as, but not limited to, an automobile, truck, bus, motorcycle, airplane, boat, or any other mobile structure for transporting humans or cargo. In a number of variations, the transparent substrate 124 may be one or more lenses in a set of smart glasses (carrier 127), or a set of goggles (carrier 127).

At least one specific purpose computer 128 may be provided and may include an electronic processor 130 operatively connected to a non-transitory computer readable memory 132 having written instructions 134 stored thereon and executable by the electronic processor 130 to control, operate or provide functionality described herein. In a number of variations, the at least one specific purpose computer 128 may be connected and operatively control at least one of the light source 102, the image producer 112, the wavelength conversion structure 104, the spatial filter 114, the beam collimation optics system 118, and/or the spatial light modulator 120.

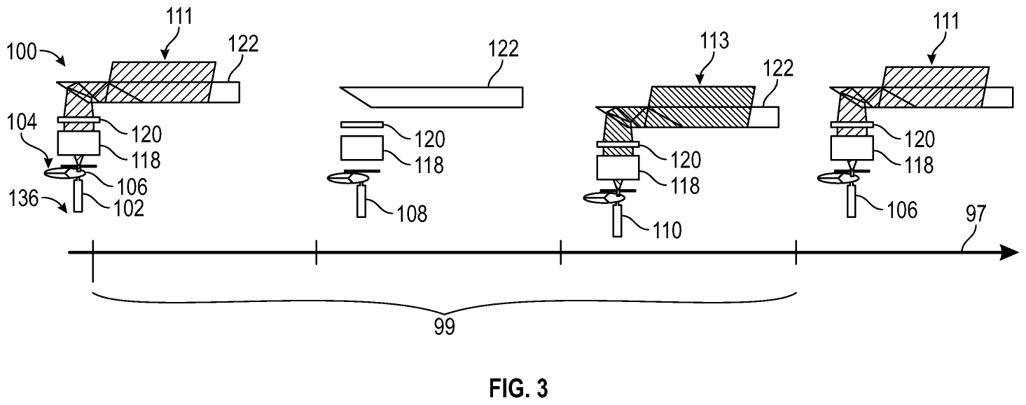

A number of variations are illustrated in FIG. 3, which may include a method of generating a full-color holographic image using the product 100, which may be a holographic projector. The wavelength conversion structure 104 is driven at three times the rate that the image producer 112 generates a frame including at least one object or image. During the time that the image producer 112 generates a frame the wavelength conversion structure 104 moves so that the first region 106 is positioned so that if any light from the light source 102 is traveling therethrough green light will be produced, thereafter the wavelength conversion structure 104 moves so that the second region 108 is positioned so that if any light from the light source 102 is traveling therethrough blue light will be produced, thereafter the wavelength conversion structure 104 is moved so that the third region 110 is positioned so that if any light from the light source 102 is traveling therethrough red light will be produced. For example, if the object or image or a portion thereof in the frame produced by the image producer 112 should appear yellow to a human observer then during the time that the frame is present the wavelength conversion structure 104 is rotated so that the first region 106 is positioned so that light passing through the first region 106 produces green light, thereafter the wavelength conversion structure 104 is rotated so that the second region 108 is positioned downstream of the light source 102 but no light is emitted from the light source so that blue light is not produced, and thereafter the wavelength conversion structure 104 is rotated so that the third region 110 is positioned and light from the light source 102 passing through produces red light. As a result, during the period that the frame 136 is present green light and red light are produced in a sufficiently short enough period of time so that a human observes the color yellow for the object or image or portion thereof. For example, if the frame is present for X Hz the SLM 120 and the wavelength conversion structure 104 are driven at a rate of 3X Hz.

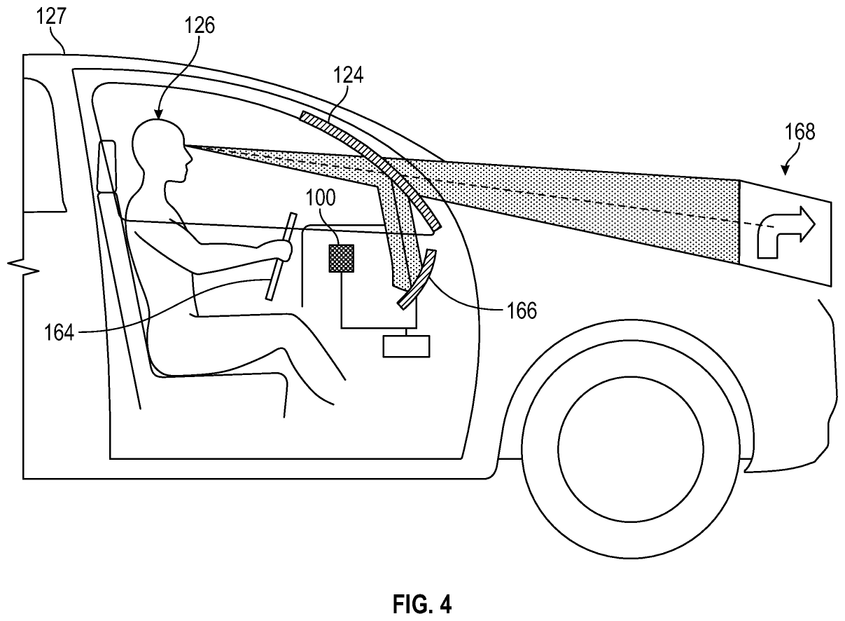

A number of variations are illustrated in FIG. 4, wherein the carrier 127 is an automobile and the human observer 126 is driving the vehicle with his hands on a steering wheel 164. The product 100 produces a holographic image which may be reflected off of a mirror 166 to the transparent substrate 124 which may be a windshield of the vehicle so that the human 126 driving the vehicle sees a holographic image 168, such as but not limited to an arrow showing the direction of the path the vehicle should take, that appears to be in the distance from the human 126 and the carrier 127, which is the vehicle.

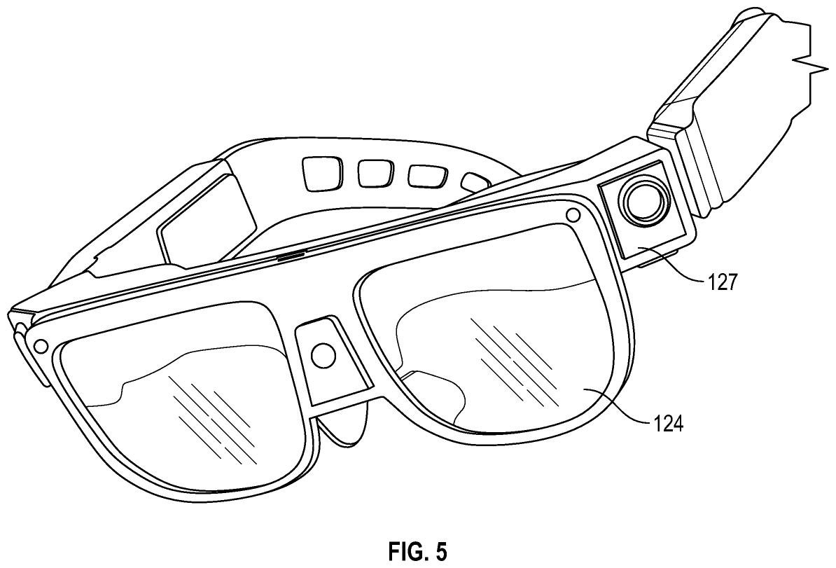

FIG. 5 illustrates the transparent substrate 124 being lenses and the carrier 127 is an eyeglass frame to be worn by a human.

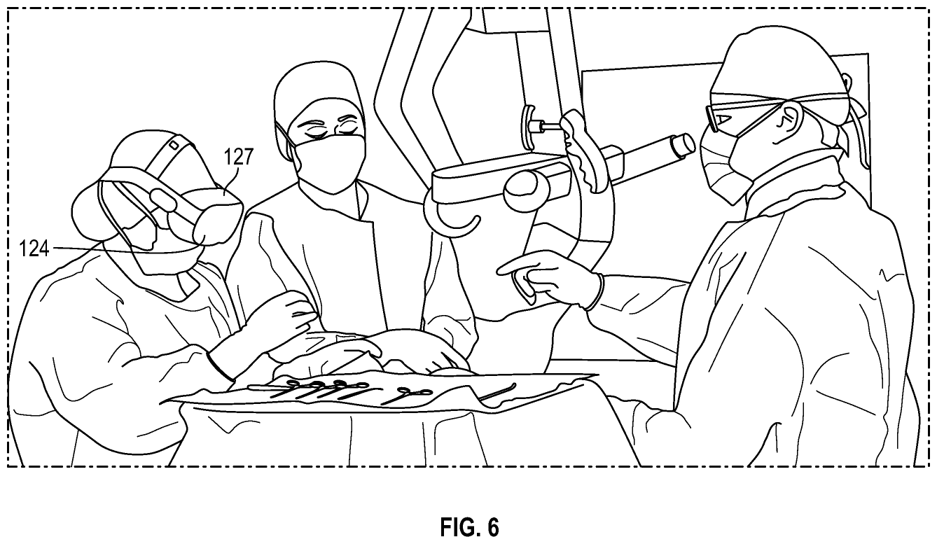

FIG. 6 illustrates the transparent substrate 124 as being lenses and the carrier 127 being a set of goggles worn by the human.

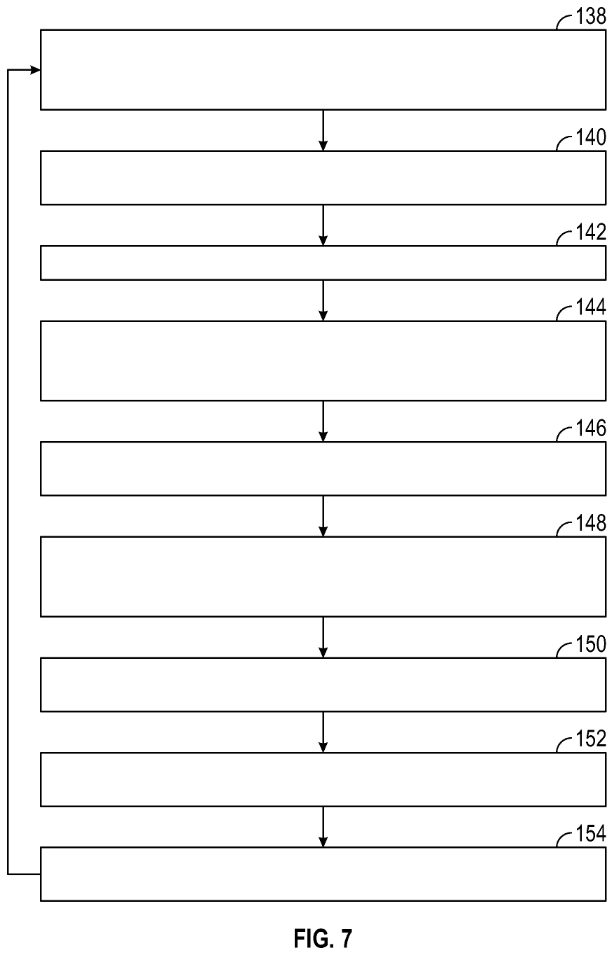

A number of variations are illustrated in FIG. 7, which may include a method including step 138 of sending a full-color video frame. For example, generating a signal from a computer or computing device and sending the signal to a DMD or MEMS causing the causing the DMD or MEMS to generate a video frame. Thereafter, in step 140, calculating a hologram for an image in the frame in three color channel. Thereafter, in step 142, determining the pulse width required for each color. Thereafter, in step 144, rotating or moving the waveguide conversion structure to the region with down conversion material for green emission. Thereafter, in step 146, addressing the SLM with hologram for green and addressing the laser with pulse width determined for green. Thereafter, in step 148, moving or rotating the wavelength conversion structure to the region with down conversion material for red emission. Thereafter, in step 150, addressing the SLM with hologram for red and addressing the laser with pulse width determined for red. Thereafter, in step 160, moving or rotating the wavelength conversion structure to the region without down conversion material. Thereafter, in step 162, addressing SLM with hologram for blue, and addressing the laser with pulse width determined for blue.

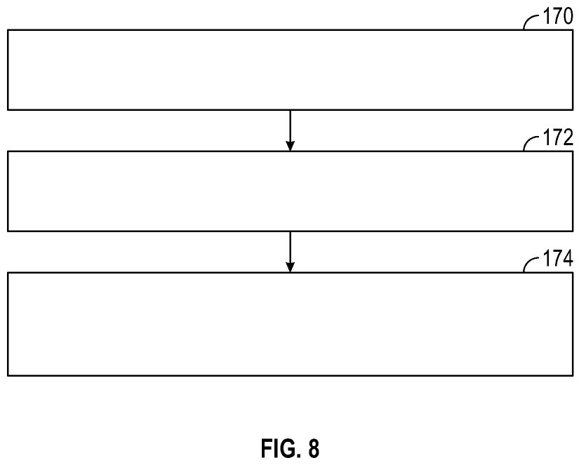

A number of variations are illustrated in FIG. 8, which may include a method including, in step 170, sending first light from a light source through a wavelength conversion structure to down convert the first light into a first primary color light. Thereafter, in step 172, sending the first primary color light through a spatial filter to convert the first primary color light to spatially coherent first primary color light. Thereafter, in step 174, sending the spatially coherent first primary color light through a spatial light modulator to convert the spatially coherent first primary color light to spatially and temporally enhanced first primary color light.

While at least one illustrative variation has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A product comprising:
a light source, a wavelength conversion structure downstream the light source, a spatial filter downstream the wavelength conversion structure, and a spatial light modulator downstream the spatial filter.

2. The product as set forth in claim 1 wherein the spatial filter includes a pinhole formed therein.

3. The product as set forth in claim 2 wherein the spatial filter is constructed and arranged to adjust a size of the pinhole.

4. The product as set forth in claim 2 wherein the pinhole has a diameter ranging from 500 micrometers to 100 micrometers.

5. The product as set forth in claim 1 wherein the wavelength conversion structure comprises at least one conversion material for selectively generating primary colors.

6. The product as set forth in claim 1 wherein the wavelength conversion structure is constructed and arranged to enhance temporal coherence.

7. The product as set forth in claim 1 wherein the spatial filter is constructed and arranged to enhance spatial coherence.

8. The product as set forth in claim 1 wherein the wavelength conversion structure and the spatial light modulator are constructed and arranged to be driven at least three times a speed of a video source.

9. The product as set forth in claim 1 wherein the wavelength conversion structure comprises a phosphor material that can be excited to produce primary colors.

10. The product as set forth in claim 1 wherein the wavelength conversion structure comprises quantum dots that can be excited to produce primary colors.

11. A method comprising:
sending a first light from a light source through a wavelength conversion structure to down convert the first light into a first primary color light;
sending the first primary color light through a spatial filter to convert the first primary color light to spatially coherent first primary color light;
sending the spatially coherent first primary color light through a spatial light modulator to convert the spatially coherent first primary color light to spatially and temporally enhanced first primary color light.

12. The method as set forth in claim 11 further comprising thereafter sending a second light from the light source through the wavelength conversion structure to down convert the second light into a second primary color light;
sending the second primary color light through the spatial filter to convert the second primary color light to spatially coherent second primary color light;
sending the spatially coherent second primary color light through the spatial light modulator to convert the spatially coherent second primary color light to spatially and temporally enhanced second primary color light.

13. The method as set forth in claim 12 further comprising thereafter sending a third light from the light source through the wavelength conversion structure to down convert the second light into a third primary color light;
sending the third primary color light through the spatial filter to convert the third primary color light to spatially coherent third primary color light;
sending the spatially coherent third primary color light through the spatial light modulator to convert the spatially coherent third primary color light to spatially and temporally enhanced third primary color light.

14. The method as set forth in claim 11 wherein the spatial filter includes a pinhole formed therein.

15. The method as set forth in claim 11 wherein the spatial filter includes a pinhole formed therein having a diameter ranging from 500 micrometers to 100 micrometers.

16. The method as set forth in claim 11 wherein the wavelength conversion structure comprises at least one conversion material for selectively generating primary colors.

17. The method as set forth in claim 11 wherein the wavelength conversion structure is constructed and arranged to enhance temporal coherence.

18. The method as set forth in claim 11 wherein the spatial filter is constructed and arranged to enhance spatial coherence.

19. The method as set forth in claim 11 wherein the wavelength conversion structure and the spatial light modulator are driven at least three times a speed of a video source.

20. A method comprising:
generating a signal from a computer or computing device and sending the signal to a digital micromirror device or a microelectromechanical system causing the digital micromirror device or the microelectromechanical system to generate an image for a video frame;
calculating a hologram for the image for the video frame in three color channel;
determining a laser pulse width required for each color;
moving a waveguide conversion structure to a region with wavelength conversion material for green emission;
addressing a spatial light modulator with the hologram for green and addressing a laser with a pulse width determined for green;
moving the waveguide conversion structure to a region with wavelength conversion material for red emission;
addressing the spatial light modulator with the hologram for red and addressing the laser with a pulse width determined for red;
moving the waveguide conversion structure to a region without wavelength conversion material;
addressing the spatial light modulator with the hologram for blue and addressing the laser with a pulse width determined for blue.
